(19) United States
(12) Patent Application Publication
(10) Pub. No.: US 2023/0044579 A1
(43) Pub. Date: Feb. 9, 2023

(54) Forecasting Malware Capabilities from Cyber Attack Memory Images

(71) Applicant: Georgia Tech Research Corporation, Atlanta, GA (US)

(72) Inventors: Moses Ike, Atlanta, GA (US); Omar Alrawi, Atlanta, GA (US); Brendan D. Saltaformaggio, Atlanta, GA (US)

(21) Appl. No.: 17/735,443

(22) Filed: May 3, 2022

Related U.S. Application Data
(63) Continuation-in-part of application No. 17/482,964, filed on Sep. 23, 2021, now abandoned.
(60) Provisional application No. 63/082,204, filed on Sep. 23, 2020.

(51) Int. Cl. G06F 21/56

(52) U.S. Cl. CPC G06F 21/566; G06F 2221/034

(57) ABSTRACT

In method of identifying capabilities of a malware intrusion that has been detected by an intrusion detection system, a notification that the malware intrusion has been detected is received from the intrusion detection system. A memory image associated with the malware is then captured. The memory image is parsed and a prior execution context is reconstructed by loading a last central processing unit (CPU) state and memory state into a symbolic environment. Addresses and prototype summaries associated with the malware are extracted from the memory image from the symbolic environment. Paths that are possible for execution due to the malware based on the addresses and prototype summaries are determined. Each path is modeled and a probability of each path being executed with concrete data is assigned. Paths with a low probability of leaving a plurality of paths of interest are pruned. Application programming interfaces (APIs) detected in the plurality of paths of interest are matched to a repository of capability analysis plugins. Any application programming interface (API) that matches at least one plugin in the repository of capability analysis plugins is reported to an analyst.

### CROSS-REFERENCE TO RELATED APPLICATION(S)

This application claims the benefit of U.S. Provisional Patent Application Ser. No. 63/082,204, filed Sep. 23, 2020, the entirety of which is hereby incorporated herein by reference.

This application is a continuation-in-part of, and claims the benefit of, U.S. patent application Ser. No. 17/482,964, filed Sep. 23, 2021, the entirety of which is hereby incorporated herein by reference.

### STATEMENT OF GOVERNMENT SUPPORT

This invention was made with government support under grant number N00014-19-1-2179, awarded by the Office of Naval Research. The government has certain rights in the invention.

### BACKGROUND OF THE INVENTION

### 1. Field of the Invention

The present invention relates to malware analysis systems and, more specifically, to a system for determining capabilities of malware once a malware intrusion has been detected.

### 2. Description of the Related Art

The remediation of ongoing cyber-attacks relies upon timely malware analysis, which aims to uncover malicious functionalities that have not yet executed. Unfortunately, this requires repeated context switching between different tools and incurs a high cognitive load on the analyst, slowing down the investigation and giving attackers an advantage.

Modern cyber-attacks last for months and infect multiple systems, but are often detected at the onset. Cyber-attack response requires countering staged malware capabilities (i.e., malicious functionalities which have not yet executed) to prevent further damages. Unfortunately, predicting malware capabilities post-detection remains manual, tedious, and error-prone. Currently, analysts must repeatedly carry out multiple triage steps. For example, an analyst will often load the binary into a static disassembler and perform memory forensics, to combine static and dynamic artifacts. This painstaking process requires context switching between binary analysis and forensic tools. As such, it incurs a high cognitive load on the analyst, slowing down the investigation and giving the attackers an advantage.

To automate incident response, symbolic execution is promising for malware code exploration, but lacks the prior attack execution state which may not be re-achievable after-the-fact (e.g., concrete inputs from C&C activity). Environment-specific conditions, such as expected C&C commands, limit dynamic and concolic techniques from predicting inaccessible capabilities. In addition, these techniques depend on dissecting a standalone malware binary or running it in a sandbox. However, malware are known to delete their binary or lock themselves to only run on the infected machine (hardware locking). Worse still, researchers have found that fileless malware incidents (i.e., that only reside in memory) continue to rise. Having access to the right execution context is necessary to guide malware into revealing its capabilities. Malware internally gather inputs from environment-specific sources, such as the registry, network, and environment variables, in order to make behavior decisions. Therefore, an ideal and practical input formulation for malware can be adapted from this internal execution state in memory bearing the already-gathered input artifacts. It turns out that anti-virus and Intrusion Detection Systems (IDS) already collect memory images of a malicious process after detecting it. A malware memory image contains this internal concrete execution state unique to the specific attack instance under investigation.

Therefore, there is a need for a post-detection technique that enables incident responders to forecast malware capabilities that are possible from a captured memory image.

### SUMMARY OF THE INVENTION

The disadvantages of the prior art are overcome by the present invention which, in one aspect, is a method of identifying capabilities of a malware intrusion that has been detected by an intrusion detection system, in which a notification that the malware intrusion has been detected is received from the intrusion detection system. A memory image associated with the malware is then captured. The memory image is parsed and a prior execution context is reconstructed by loading a last central processing unit (CPU) state and memory state into a symbolic environment. Addresses and prototype summaries associated with the malware are extracted from the memory image from the symbolic environment. Paths that are possible for execution due to the malware based on the addresses and prototype summaries are determined. Each path is modeled and a probability of each path being executed with concrete data is assigned. Paths with a low probability of leaving a plurality of paths of interest are pruned. Application programming interfaces (APIs) detected in the plurality of paths of interest are matched to a repository of capability analysis plugins. Any application programming interface (API) that matches at least one plugin in the repository of capability analysis plugins is reported to an analyst.

In another aspect, the invention includes a post-detection technique that enables incident responders to predict capabilities which malware have staged for execution automatically. It is based on a probabilistic model that helps an analyst to discover capabilities and also weigh each capability according to its relative likelihood of execution (i.e., forecasts). It leverages the execution context of the ongoing attack (from the malware's memory image) to guide a symbolic analysis of the malware's code.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1B show a system workflow in which a memory image is used to reconstruct the original execution context, in which concrete data is utilized to explore code paths in a probabilistic fashion and API constraints are analyzed against plugins to forecast capabilities.

FIG. 2A shows symbolic exploration for the control-flow graph, memory and register values from the memory image.

FIG. 2B shows value derivation for degree of concreteness (D_{c}(s)).

FIG. 2C shows a plot of cumulative ratio versus states.

FIG. 2D shows a Plot of D_{c}(s) versus states.

FIG. 3 shows API Constraints-based Analysis of AveMaria Capabilities: File Exfiltration, Code Injection, and Spying.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

If one can animate the code and data pages in a memory image, and perform a forward code exploration from that captured snapshot, then these early concrete execution data can be reused to infer the malware's next steps. Further, by analyzing how these concrete inputs induce paths during code exploration, one can predict which paths are more likely to execute capabilities based on the malware's captured execution state. Based on this idea, the present invention seeds the symbolic exploration of a malware's pre-staged paths with concrete execution state obtained via memory image forensics. This overcomes the previous painstaking and cognitively burdensome processes that analysts in the past would undertake.

The post-detection technique of the inventive system enables incident responders to forecast what capabilities are possible from a captured memory image. The system ranks each discovered capability according to its probability of execution (i.e., forecasts) to enable analysts to prioritize their remediation workflows. To calculate this probability, the technique weighs each path's relative usage of concrete data. This approach is based on a formal model of the degree of concreteness (or D_{c}(s)) of a memory image execution state (s). Starting from the last instruction pointer (IP) value in the memory image, it explores each path by symbolically executing the CPU semantics of each instruction. During this exploration, it models how the mixing of symbolic and concrete data influences path generation and selection. Based on this mixing, a “concreteness” score is calculated for each state along a path to derive forecast percentages for each discovered capability. D_{c}(s) also optimizes symbolic analysis by dynamically adapting loop bounds, handling symbolic control flow, and pruning paths to reduce path explosion.

To identify each capability automatically, the system employs several modular capability analysis plugins: Code Injection, File Exfiltration, Dropper, Persistence, Key & Screen Spying, Anti-Analysis, and C&C URL. Each plugin defines a given capability in terms of Application Programming Interface (API) sequences, their arguments, and how their input and output constraints connect each other. Because these plugins are portable and can be extended to capture additional capabilities based on the target system's APIs, an analyst can extend them to capture additional capabilities, by checking the API documentation of the target operating system. The system's analysis only requires a forensic memory image, allowing it to work for fileless malware, making it well-suited for incident response.

In one experimental embodiment, the system was evaluated with memory images of real-world malware (including packed and unpacked) covering families. It was found that the system renders accurate capability forecasts compared to reports produced manually by human experts. Also, the system is robust against futuristic attacks that it aims to subvert. It was found that the system's post-detection forecasts are accurately induced by early concrete inputs.

The disclosure below presents the challenges and benefits of combining the techniques of memory image forensics and symbolic analysis. Using the DarkHotel incident as a running example, it will be shown how incident responders can leverage to expedite their investigation and remediate a cyber-attack.

DarkHotel is an advanced persistent threat (APT) that targets chief-level (C-level) executives through spear phishing. Upon infection, DarkHotel deletes its binary from the victim's file system, communicates with a C&C server, injects a thread into Windows Explorer, and ultimately exfiltrates reconnaissance data. When an IDS detects anomalous activities on an infected host, an end-host agent captures the suspicious process memory (e.g., DarkHotel's), terminates its execution, and generates a notification. At this point, incident responders must quickly understand DarkHotel's capabilities from the different available forensic sources (network logs, event logs, memory snapshot, etc.) to prevent further damages.

Dynamic techniques may require an active C&C, which may have been taken down, to induce a malware binary to reveal its capabilities. Because DarkHotel only resides in memory, these techniques, which work by running the malware in a sandbox, cannot be applied. With only the memory image, an analyst can use a forensic tool, such as Volatility, to “carve out” the memory image code and data pages. Based on the extracted code pages, symbolic analysis can simulate the malware execution in order to explore all potential paths. Unfortunately, existing symbolic tools require a properly formatted binary and are not optimized to work with memory images.

Ideally, an analyst can manually project these code fragments into symbolic analysis and source concrete values from the data pages to tell which code branch leads to a capability. However, this back-and-forth process of “stitching up” code with extracted memory artifacts, involves context switching between symbolic execution and the forensic tool. This places a very high cognitive burden on the analyst. An analyst must also handle challenges such as path explosion, API call simulation, and concretizing API arguments (e.g., attacker's URL), which may not be statically accessible in the memory image. Lastly, an analyst must manually inspect APIs along each path to infer high-level capabilities.

Incident responders rely on memory forensics to identify attack artifacts in memory images. However, memory forensics alone, which is largely based on signatures, misses important data structures due to high false negatives. On the other hand, symbolic execution can explore code in the forward direction, but suffers from issues such as path explosion. To address these limitations, the system combines symbolic execution and memory forensics through a feedback loop to tackle the shortcomings of both techniques.

Context-Aware Memory Forensics: Symbolic analysis provides code exploration context to accurately identify data artifacts that are missed by memory forensics. For example, traditional forensic parsing of DarkHotel's memory image missed C&C URL strings because they are obfuscated via a custom encoding scheme. However, subsequent symbolic analysis of the instructions that reference those bytes as arguments, such as a strncpy API, allow the system to identify and utilize these data artifacts correctly in the memory image.

Augmented Symbolic Analysis: Memory image forensics provides concrete inputs that can help symbolic analysis perform address concretization, control flow resolution, and loop bounding. In addition, memory forensics identifies loaded library addresses in memory which allows the system to perform library function simulation.

Path Probability: Given a memory image, the goal is to utilize available concrete data to explore potential code paths and forecast capabilities along them. By analyzing how different paths are induced by concrete memory image data, the system can derive the probability that a path will reach a capability relative to other paths. The system computes this probability based on modeling how concrete and symbolic data operations are influencing path generation and selection. The system also leverages this probability metric as a heuristic in pruning paths with the least concrete data.

Probability-based Argument Concretization: Arguments to future API calls may not be directly accessible in a memory image if they are generated at run-time. For example, DarkHotel's URL string was encoded and not statically recoverable from its memory image. As such, when analyzing API calls, the system represents these arguments as symbolic to capture all possible values. However, the concrete value may be necessary to characterize a malware's capability. For example, DarkHotel's URL string was used to communicate with a C&C server. To concretize symbolic arguments, the system selects a concrete value for the argument such that, if that value is selected out of the set of the possible values, it will result in the highest state probability score relative to other paths. This can be referred to as “probability-based concretization.”

The system identifies capabilities originating from a malware memory image in an automated pipeline. To demonstrate this, the experimental embodiment simulated DarkHotel's attack and memory capture, which involved setting up an IDS with DarkHotel's network signature and executing the Advanced Persistent Threat (APT). Following detection, the IDS signals the end host agent to capture the DarkHotel process memory. The experimental embodiment then input this memory image to for analysis. In 459 seconds, the system reveals DarkHotel's capabilities: a C&C communication (i.e., mse.vmmnat.com), a file exfiltration (i.e., of host information), and a code injection (i.e., into Windows Explorer).

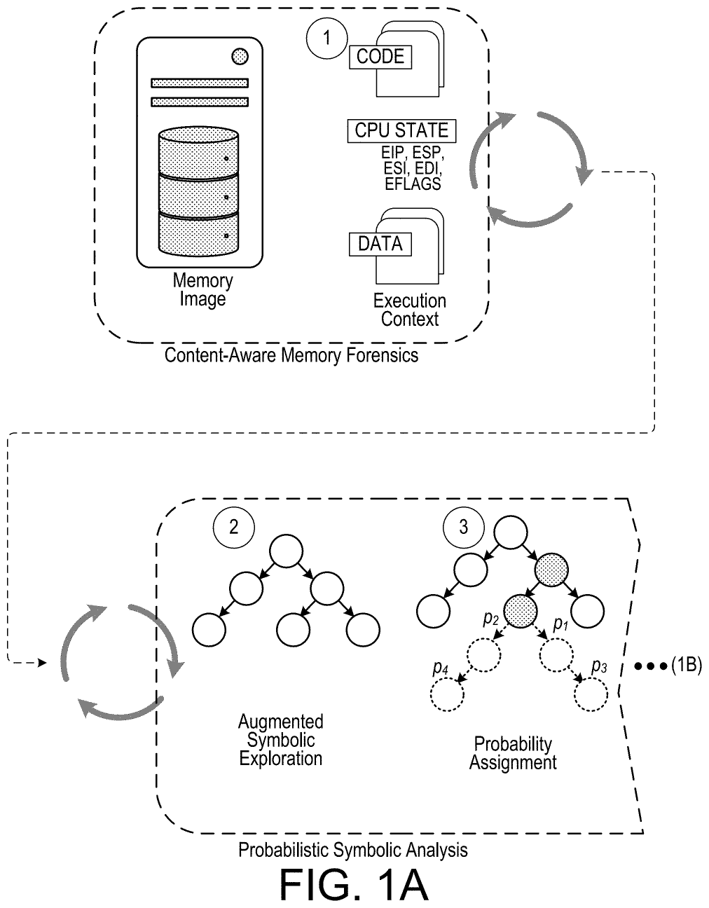

As shown in FIG. 1, one there are six stages for processing a forensic memory image. The system forensically parses the memory image and reconstructs the prior execution context by loading the last CPU and memory state into a symbolic environment for analysis 1. In analyzing the memory image, the system inspects the loaded libraries to identify the exported function names and addresses. Next, the system proceeds to explore the possible paths, leveraging available concrete data in the memory image to concretize path constraints 2. The system models and weighs how each path is induced by concrete data and assigns a probability to each generated path 3. The system then uses this probability as a weight to adapt loop bounds and prune false paths, allowing the system to narrow-in on the induced capability-relevant paths 4. The system matches identified APIs to a repository of capability analysis plugins to report capabilities to an analyst 5. Finally, the system identifies three capabilities and derives their forecast percentages from the path probabilities as (in the experimental embodiment) 31%, 15%, and 54%, respectively 6.

In the experimental embodiment, the first path matches the Code Injection plugin. This path contains the APIs: VirtualAllocEx, WriteProcessMemory, and CreateRemoteThread, which are used in process injection. Analyzing the argument constraints leading to these APIs reveals explorer.exe as the target process. The second path matches the File Exfiltration plugin. This path contains APIs getaddrinfo, SHGetKnownFolderPath, WriteFile, Socket, and Send. The system inspects their arguments' constraints to determine that the malware writes host information to a file, which it sends over the network. The File Exfiltration plugin concretizes the argument of SHGetKnownFolderPath to reveal the file location identifier: FOLDERID_LocalAppData. The third path matches the C&C Communication plugin, which reveals a sequence of network APIs including InternetOpenUrlA. The plugin queries the API constraints and concretizes InternetOpenUrlA's argument then reports that DarkHotel makes an HTTP request to the mse.vmmnat.com domain.

Given these forecast reports, an incident responder learns from the captured memory snapshot that DarkHotel will communicate with mse.vmmnat.com, steal host data, and inject into Windows Explorer. This will prompt the analyst to block the URL and clean up the affected Explorer process mitigating further damages. The system empowers the analyst to respond to threats quickly and efficiently by alleviating the cognitive burden and context switching required to obtain the same results manually.

System Architecture: The system includes a post-detection cyber incident response technique for forecasting capabilities in malware memory images. It requires only a memory image as input. The output of can be a text report of each discovered capability (e.g., code injection), a forecast percentage, and the target of the capability (e.g., injected process).

Reconstructing Execution Context: The system parses the memory image to extract the execution state (e.g., code pages, loaded APIs, register values, etc.) to be used to reconstruct the process context. Static analysis of the code pages is used to initialize symbolic exploration. It explores each path beginning from the last IP in the reconstructed process context. Static analysis of the code pages is used to initialize symbolic exploration. It explores each path beginning from the last IP in the reconstructed process context. Concrete data values are fed back into control flow decisions to concretize path constraints.

Code and Data Page Analysis: The system symbolically executes the CPU semantics of the disassembled code pages until an undecidable control flow is encountered. To resolve this, the system recursively follows the code blocks to resolve new CFG paths. When a library call is reached, the system simulates and symbolizes the call (as discussed in more detail below). Library call simulation introduces symbolic data for each explored state, thus increasing the possibility of state explosion. However, the D_{c}(s) model (as discussed below) provides optimization metrics that enable to dynamically adapt parameters for loop bounding, symbolic control flow, and path pruning.

Modeling Concreteness to Guide Capability Forecasting: The system models how available concrete data in a memory image induces capability-relevant paths using the degree of concreteness model (D_{c}(s)). Degree of concreteness is a property of execution states which encapsulates the “mixing” of symbolic and concrete operations. Symbolic operations (Sym_Ops) make use of symbolic variables such as arithmetic involving symbolic operands. Concrete operations (Con_Ops) do not make use of symbolic variables. Sym_Ops and Con_Ops are intrinsic to every state transition. A state transition happens each time a basic block is executed along an explored path. Based on the ratio of Sym_Ops to Con_Ops, there exists an associated degree of concreteness (D_{c}(s)) value, which measures how concrete or symbolic the current execution state is.

Forecasting is based on malware's use of pre-staged concrete data to execute a set of capabilities. Under D_{c}(s), paths that increasingly utilize concrete states are more likely to reach a set of capabilities. As a result, the system assigns D_{c}(s) scores to states by modeling their cumulative usage of concrete data. This D_{c} (s) score is then used to derive the probability, P_{prob} (s), that a path will reach a capability relative to other paths. At the end of exploration, the paths where capabilities are found are analyzed based on their P_{prob} (s), to compute forecast percentages of identified capabilities.

In addition to deriving forecasts, D_{c}(s) detects conditions that trigger path explosion (e.g., rapid path splitting due to symbolic control flows), and makes performance improvements including pruning false states based on the degree of concreteness of every active state.

For D_{c}(s) to forecast capabilities, it must summarize two key features: (1) the rate of change in the ratio of symbolic operations to all operations, with respect to state transitions, and (2) the cumulative state conditions from a starting exploration state j to a target state n. The system normalizes D_{c}(s) with respect to the number of states explored in our model. This bounds its value between 0.0 and 1.0, which describes the current state mixing. Formally, the system defines a state transition set τₙ, which is a set of ordered states from sⱼ to sₙ:

τₙ:={Sⱼ,Sⱼ+1,Sⱼ+2, . . . ,Sₙ} (1)

where state sⱼ is the first state generated from a memory image and 0≤j≤n, n ∈ [symbol] . Transitioning from state sᵢ₋₁ to sᵢ involves executing every operation (All_Opsᵢ₋₁) in the basic block BBᵢ₋₁ at state sⁱ⁻¹. The states in τₙ are ordered based on the basic block ordering, i.e., the basic block BBᵢ maps to state sᵢ, and executing BBᵢ transitions the program's context to BBᵢ₊₁ and state sᵢ₊₁. The set All_Opsᵢ is partitioned into 2 disjoint sets, Sym_Opsᵢ and Con_Opsᵢ, such that:

Symn_Opsᵢ∪COn_Opsᵢ=All_Opsᵢ (2)

and

Sym_Opsᵢ∩Con_Opsᵢθ (3)

For a state sₙ, we define the D_{c}(sₙ) function as follows:

$${D}_{C} ( {s}_{n} ) = 1 - \frac{{\sum }_{i = j}^{n} \frac{\vert {Sym\_Ops}_{i} \vert}{\vert {All\_Ops}_{i} \vert}}{\vert {τ}_{n} \vert} \qquad ( 4 )$$

where |Sym_Opsᵢ| is the cardinality of the Sym_Ops performed to reach state sᵢ and |All_Opsᵢ| is the cardinality of All_Ops performed to reach state sᵢ. Further, |τₙ| is the cardinality of the state transitions from state sⱼ to sₙ.

Tracking the cumulative ratio of Sym_Opsᵢ to All_Opsᵢ for each state transition enables the system to calculate D_{c}(s) instantaneously without iterating through the previous states sⱼ to sₙ. An extended form of D_{c}(s) that allows the system to calculate its instantaneous value is given as follows:

$${D}_{C} ( {s}_{n} ) = 1 - \frac{δ}{δ T} Cumul\_Ratio ( {s}_{n} ) \qquad ( 5 )$$

where, for all transition states T, Cumul_Ratio(sₙ) is the sum of the states' ratio for states sⱼ to Sₙ, and defined as:

$$\{ ∀ {s}_{i} ∈ T \text{:} {Cumul}_{-} Ratio ( {s}_{n} ) := {\sum }_{i = j}^{n} \frac{\vert {Sym\_Ops}_{i} \vert}{\vert {All\_Ops}_{i} \vert} \} \qquad ( 6 )$$

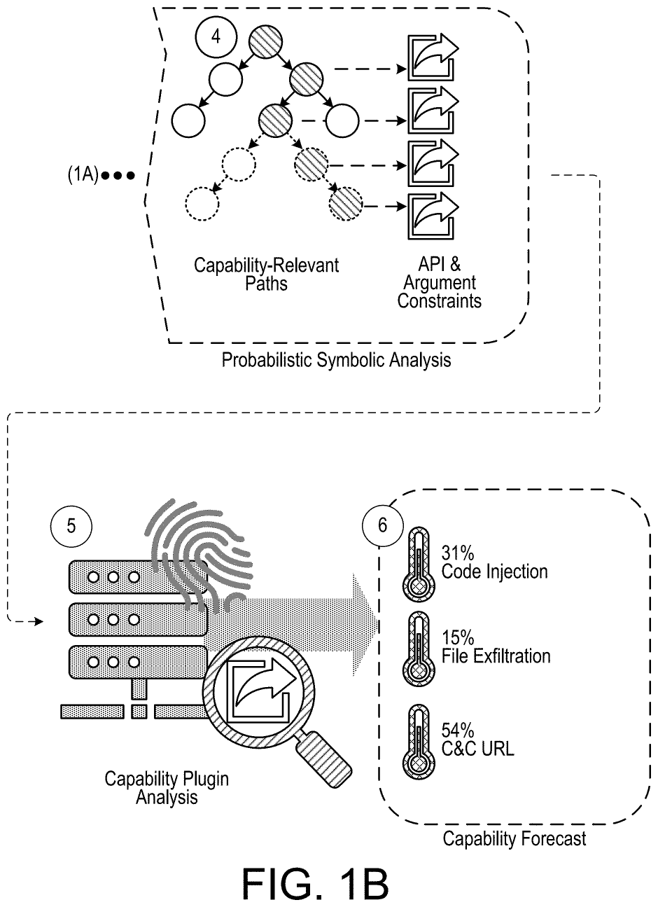

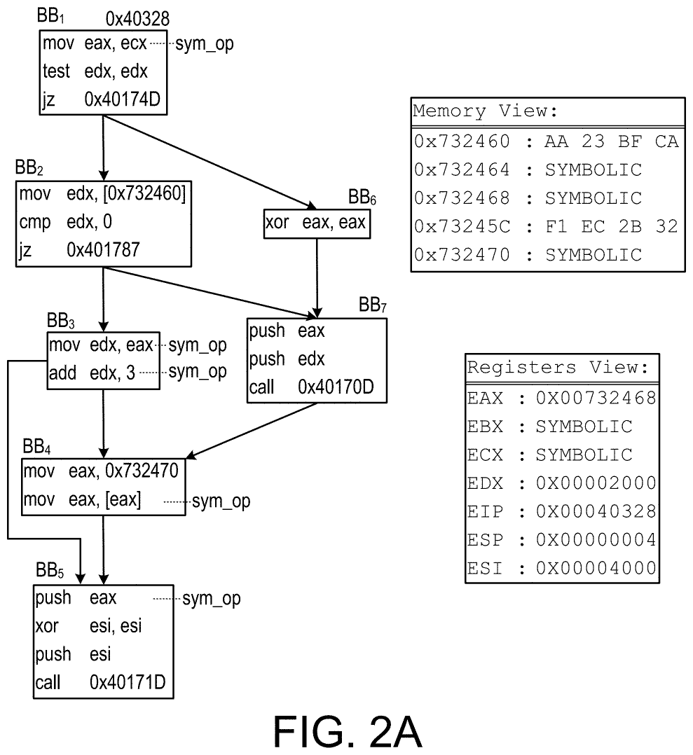

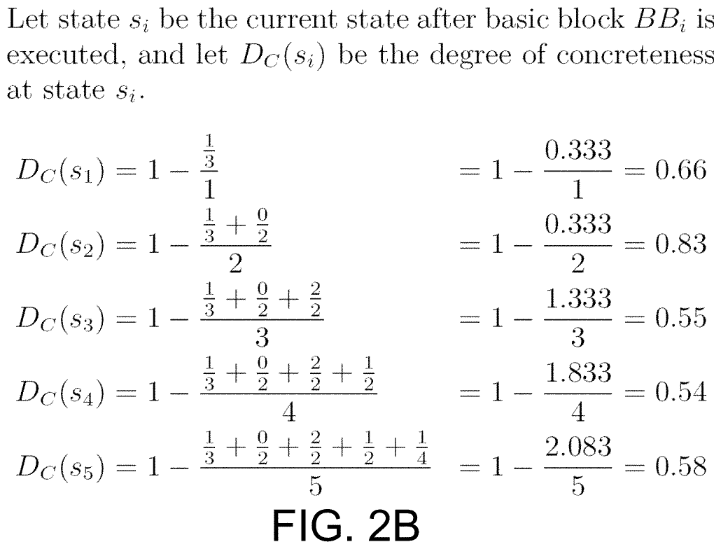

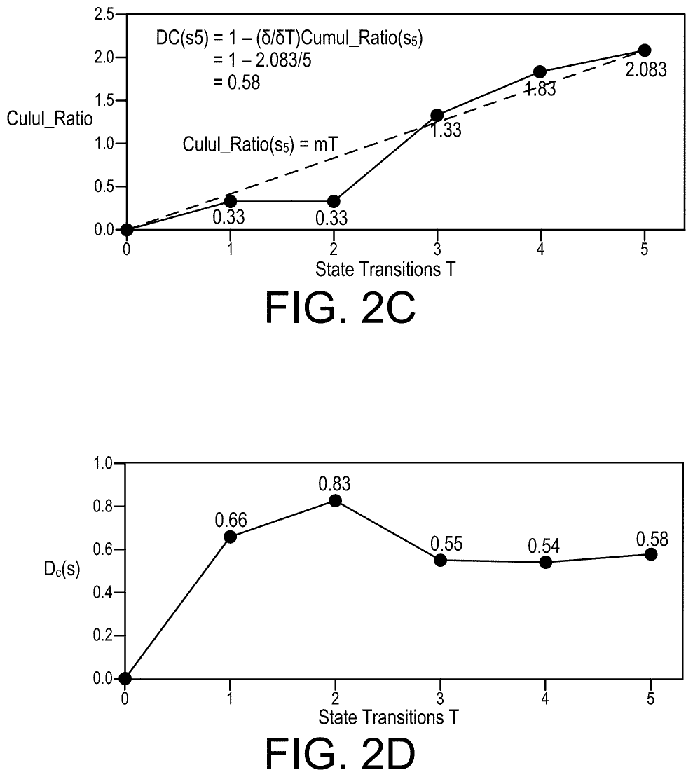

As shown in FIGS. 2A-2D, the system recovers context from the process memory image, including the memory values and register values for the captured state in FIG. 2A. Using the degree of concreteness (D_{c}(s)) formula, FIG. 2B calculates the values for each transition state. As shown in FIG. 2C, the system plots the cumulative ratio of Sym_Ops to All_Ops accumulated across state transitions. A plot of the degree of concreteness (D_{c}(s)) across state transitions in the symbolic exploration is shown in FIG. 2D.

FIG. 2C shows D_{c}(s) for the end state sₙ (n=5) using the iterative form and the instantaneous D_{c}(s) form (dashed line). The Cumul_Ratio(sₙ) function is a straight line (Cumul_Ratio(sₙ)=mT) drawn from origin to the point sₙ 2 T, where m is the slope. Taking the derivative of Cumul_Ratio(sₙ)=mT gives the instantaneous D_{c}(sₙ). Path Probability: Given m current states, the path probability of a path p, with current state s, is derived by dividing s's D_{c}(s) by the summation of the D_{c}(s) of all m states. This bounds its value between 0:0 and 1:0, and is given as follows:

$$\{ {P}_{prob} ( {s}_{x} ) = \frac{{D}_{C} ( {s}_{x} )}{{\sum }_{i = 1}^{m} {D}_{C} ( {s}_{i} )} , m = \vert \{ AllCurrentStates \} \vert \} \qquad ( 7 )$$

Algorithmic Approach to D_{c}(s): In order to derive D_{c}(s), the system uses Algorithm 1. Cumul_Ratio is the cumulative ratio of symbolic operations to all operations, and T is the total state transitions in terms of basic blocks. For each explored path p in the memory image, D_{c}(S) is calculated for every state s generated and executed along the path p.

Algorithm 1 The Degree of Concreteness (D_{C}(s) )

```
Input: PATHS: Explored program paths in a memory image
Output: D_{C}(s): ∀s ∈ path, ∀path ∈ PATHS [symbol]
            Initialize Cumul_Ratio for each explored path p
  for path p ∈ PATHS do
    Cumul_Ratio ← 0
    T ← 0 [symbol]
          Compute D_{C}(s) for each state s generated along p
    for State s ∈ SuccessorStates(p) do [symbol]
                  Get Sym_Ops and All_Ops
      Num_all_ops ← GetNumAllOps(s)
      Num_sym_ops ← GetNumSymOps(s) [symbol]
        Calculate the ratio of Sym_Ops to All_Ops for state s
      Sym_Ratio ← Num_sym_ops/Num_all_ops [symbol]
              Update Cumul_Ratio along the explored path
      Cumul_Ratio ← Cumul_Ratio + Sym_Ratio [symbol]
                Compute D_{C}(s) for the considered state s
      D_{C}(s) ← Cumul_Ratio/T
      T + +
```

A working example to show the computation of D_{c}(s) is shown in FIGS. 2A-2D. FIG. 2A depicts a recovered CFG and memory and register values from the memory image. Symbolic execution starts at basic block BB₁ and ends at BB₄. Rach basic block is annotated to show which instructions are Sym_Ops based on the register or memory values when the basic block is being executed. In this example, because register edx at BB₂ and memory address 0×732460 at BB₂ have concrete values, only one branch is taken by the conditional jump instructions at the end of BB₂. For this reason, BBₛ is not explored. Symbolic data can be introduced by I/O-related function calls and calls to functions that are simulated based on the system's function models. Such function calls create symbolic variables within the memory dump which causes a mixing of symbolic and concrete data. Following along with FIG. 2A, FIG. 2B computes D_{c}(s) for each state (basic block) transition. For example, D_{c}(s₁)=0.67 when we transition to state s₂, then it increases to 0.83 as we transition from s₂ to S₃. For each D_{c}(sᵢ) value derived in FIG. 2B, the system plots them against the transition states in FIG. 2D. FIG. 2C plots the Cumul_Ratio(sᵢ) for each state. The instantaneous Cumul_Ratio(sₙ) function is a straight line (Cumul_Ratio(sₙ)=mT) drawn from origin to the point sₙ ∈ T, where m is the slope. The derivative of Cumul_Ratio(sₙ)=mT gives the instantaneous D_{c}(sₙ) ( ).

Given m current states, the path probability of a path p, with current state s, is derived by dividing s's D_{c}(s) by the summation of the D_{c}(s) of all m states. This bounds its value between 0.0 and 1.0. In order to derive D_{c}(s), uses. Cumul_Ratio is the cumulative ratio of symbolic operations to all operations, and T is the total state transitions in terms of basic blocks. For each explored path p in the memory image, D_{c}(s) is calculated for every state s generated and executed along the path p.

As shown in FIGS. 2A-2D, the system recovers context from the process memory image, including the memory values and register values for the captured state in FIG. 2A. Using the degree of concreteness (D_{c}(s)) formula, as shown in FIG. 2B, the system calculates the values for each transition state. A plot of the cumulative ratio of Sym_Ops to All_Ops accumulated across state transitions is shown in FIG. 2C and a plot of the degree of concreteness (D_{c}(s)) across state transitions in the symbolic exploration is shown in FIG. 2D.

D_{c}(s)-Guided Symbolic Analysis: The system uses D_{c}(s) to optimize symbolic execution multi-path exploration by bounding loops, concretizing addresses for symbolic control flow, and pruning paths. Neglecting these parameters impacts soundness and performance. State-of-the-art tools rely on hard-coded thresholds to balance the trade-off between coverage and soundness. These techniques mostly focus on finding bugs in non-malicious code. Choosing an informed threshold is application-specific and may require a manual investigation. Yet, unlike finding bugs, malware employ adversarial means to vary these issues at run-time, hence a hard-coded or manual threshold will be limiting. However, by modeling the changing concrete state of an exploration, the system can dynamically adapt these (otherwise application-specific) thresholds at run-time. D_{c}(s) embodies this automated adaptability to optimize exploration.

Adapting Loop Bounds: the system optimizes loops by forcing a bound only when D_{c}(s) indicates a heavy symbolic state over time (specifically, when D_{c}(s) drops below 0.10 after 10 state transitions). This optimization precisely measures how much a loop is affecting a state to decide when to bound it. It is observed that, unlike harmless loops, explosion-causing loops converge D_{c}(s) to 0.10 after two or more transitions.

Deriving Tractable Symbolic Memory Indices: Per D_{c}(s) formulation, the effects of symbolic indices access are quickly detected under the D_{c}(s) model. When faced with symbolic memory indices, the system first concretizes it to a tractable range by filtering out addresses that do not point to mapped data regions in the memory image. Given such a tractable range, the system can efficiently perform conditional memory accesses. In one experimental prototype, the system derived a range parameter of 256×D_{c} (s) for writes and 2048×D_{c} (s) for reads, which improved both performance and coverage.

Managing Symbolic Control Flow. When faced with symbolic control flow, the system uses the D_{c}(s)-derived path probability scores, P_{prob} to down-select successive child paths to a manageable space. The system then further invokes a concretization strategy to narrow-down the correct successor state. This is achieved by analyzing the forensic stack backtrace and memory image layout.

On-Demand State Merging and Pruning: When performance is overwhelmed by heavy state symbolism, the system prioritizes states for pruning by selecting the worst performers. Under D_{c}(s), this selection is trivial since every state has a D_{c}(s) score, which is used to prune states with heavy symbolic footprints. It was found that on-demand pruning drove toward more concrete paths than tools which prune paths via a hard-coded threshold −leading to exploring deeper in selected paths.

Memory Image Context in Symbolic Exploration: Path explosion and poor support for library calls are major hurdles in symbolic analysis. The system tackles them by: (1) analyzing the stack backtrace to prune false successor states; (2) performing address concretization based on the process memory layout; and (3) simulating API calls via analysis of loaded library functions in the memory image.

Stack Backtrace Analysis. False successor paths often arise in symbolic analysis. The system examines the return addresses on the stack in a memory image to identify false paths—function returns that do not conform to previously established targets in the call stack. Specifically, the stack backtrace enables to verify flow-correctness by comparing the stack pointer and return addresses in the backtrace with that computed after executing a return instruction.

Address Concretization: When faced with symbolic memory indices, the system uses the memory image data space to concretize symbolic indices to a tractable range. In addition, it was observed that false states perform illegal indices accesses (indices beyond the mapped code/data space of a process). The system uses this indicator to prune such states. Further, the system's analysis is transparent to address space layout randomization (ASLR) because ASLR is done at process load, before execution.

The system analyzes the libraries present in the memory image to identify the exported functions. Identified functions are hooked to redirect the symbolic exploration to a simulated procedure. The system also handles dynamic library loading by calls to the LoadLibrary functions. If a library is loaded during symbolic exploration, creates a new section in memory for the loaded library. Once a call to GetProcAddress is reached, a new address is allocated in the library's memory section and hooked, then this address is returned. Any calls made to this address will be redirected to the correct simulated procedure.

Library Function Simulation: The system analyzes a memory image to extract addresses and prototype summaries of loaded library functions. This provides the information needed for the system to simulate an API's effect on a symbolic state without symbolically executing the code. The system analysis on the function summaries yields (1) the number of arguments to the function, (2) type of arguments, (3) calling convention, and (4) the return register. This knowledge-base to enable this is generated off-line using the Windows API documentation toolset and given to the system during memory image parsing step. On encountering an API call, the system leverages the function summaries and performs the following steps: 1. Sets the return register of the function as symbolic and constrains its value to the possible values specified by the function prototype information. 2. If the function writes to a memory location (i.e. if the nature of one of its arguments signifies an output buffer), the system marks that memory location symbolic. 3. Depending on the calling convention, the system adjusts the stack accordingly and modifies its symbolic state as if it has returned from that library function. Then, the system continues to the next instruction. In adjusting the stack, the system focuses on calling conventions where the callee cleans the stack. For example, in stdcall, the system manipulates the state and pops arguments it previously pushed to stack prior to the call. The experimental embodiment extensively tested the simulation approach by verbosely logging and verifying the simulation effect of any encountered API calls. To ensure that the approach is error-free and preserves the soundness of execution flow, the system conducts checks by correlating state transitions with prior forensic analysis facts. Specifically, the system ensures that execution flow adhered to already established caller-to-callee relationships in the stack backtrace, and that the stack pointer and return addresses in the backtrace matched their corresponding counterparts during function returns.

Forecasting Malware Capabilities: To characterize high-level capabilities, the system focuses on contextualizing a malware's API functionality by analyzing the constraints on their input and output parameters. The system analyzes the symbolic constraints on the input and output parameters of each API to “connect the dots” between APIs. Analyzing APIs used by malware is useful for identifying its capabilities because a malware's behavior stems from its API calls and data flow. Specifying a unique trace involves identifying the first (source) and last (sink) API in the sequence. Some existing systems rely on dynamic taint-tracking, which may not be applied here. To tackle this, the system leverages a constraint matching technique to model malware's decision making. This approach is based on the formulation that for a given API trace to embody a capability, the path constraints on the input of each succeeding API starting from the sink, can be matched to the output constraints of at least one preceding API.

When a sink is encountered, the system performs a call-based backward slice to record all call instructions such that, for each instruction, there is a data flow from at least one of its operands to the input argument of the sink. If the extracted slice includes a corresponding source, the system proceeds to match the constraints on the input of every succeeding call, starting from the sink, to the output of any preceding call. Traditional system call/API tracing often misses malware capabilities due to a lack of contextual connection between observed APIs. Therefore, the system uses the constraints on the API parameters in this call-based backward slice to precisely connect the data flow between the APIs to infer capabilities. Put simply: The constraints encapsulate only the relevant data flow between sources and sinks.

Probability-based Argument Concretization: To determine the concrete value of an API's argument of interest, the system selects the value that is assigned to the state that attains the highest probability metric, or P_{prob}(s). The probability-based concretization approach is based on the formulation that the correct value of an argument, if selected (i.e., out of the possible values) to explore the given path, will attain the best path probability metric. In symbolic analysis, symbolic inputs such as an API argument often encapsulate several possible values. This often results in the affected path forking into many paths, with each path bearing one possible value. As a trade-off between coverage and soundness, some existing techniques proceed by selecting one possible value. The system analyzes each of the forked path's probability scores, P_{prob}(s), to predict which path has the correct value. Per the formulation of P_{prob}(s) from D_{c}(s), the true path (i.e., the path bearing the correct concrete value) will reflect a higher cumulative P_{prob}(s) relative to the other false paths over time. That is, if si is the current state of the path that was given the correct value, then,

{∀SⱼSᵢ∈AllStates:PathProb(Sᵢ)>PathProb(Sⱼ)} (8)

By inducing symbolic inputs on API arguments of known concrete values, it was found that the probability scores of the states provided with the correct concrete input attained the highest path probability. Moreover, as execution on this input progresses along successive child states during exploration, the true path's current state P_{prob}(s) score remains consistently higher than other analyzed states. Further, when a given input value is ultimately selected as the correct concrete value, the system employs a constraint solver (Z3) to verify that the input satisfies the constraints on the path under analysis. Using this approach, the system concretizes many symbolic API arguments of interests including filenames and URLs.

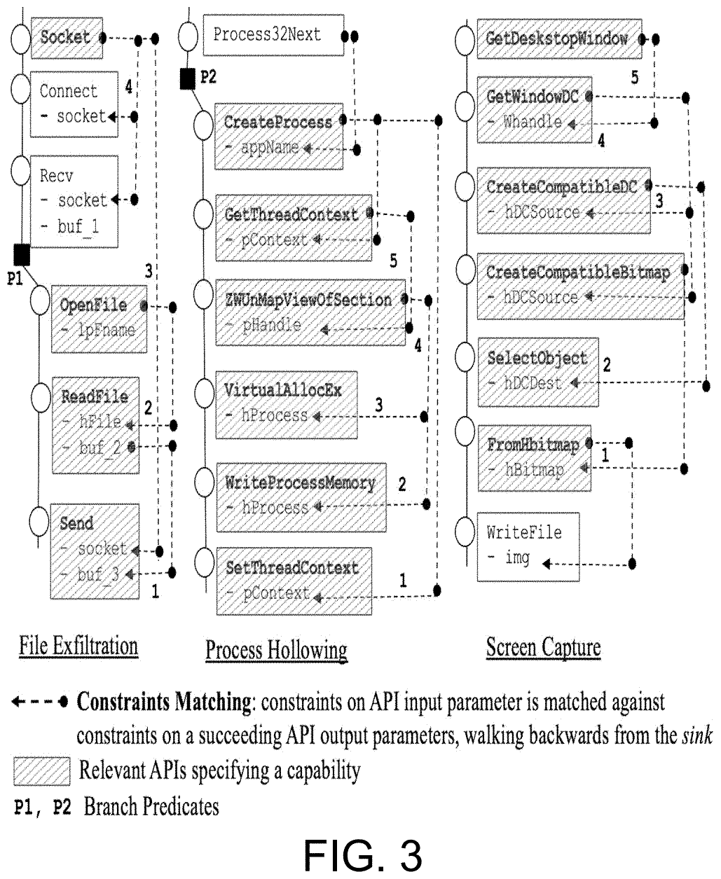

An experimental example of API Constraints-based Analysis of AveMaria Capabilities is shown in FIG. 3, which includes file exfiltration, code injection, and spying. This analysis is based on AveMaria, a Trojan that steals Firefox cookie files. AveMaria infects by replacing the code of Svcshost, a Windows service, with its own code, a code injection capability known as process hollowing. AveMaria also takes screenshots to spy on the user's screen. The shaded boxes FIG. 3 are the relevant APIs in the trace and their key arguments. The dotted line matches the input constraints on an argument of a latter API to the output constraints of at least one preceding API. The analysis starts when a sink is identified (e.g., SetThreadContext for AveMaria's Code Injection) and the entire trace is recovered by a call-based backward slice. The numbers, 1, 2, etc., show the constraint matching steps, starting from the sink and walking backwards to a source. In AveMaria's File Exfiltration, the constraints on the input file (buf_3) exfiltrated by send are matched with the constraints on buf_2, an output argument of ReadFile. Next, the constraints on the file handle (hFile) of ReadFile are matched with the constraints on the output of OpenFile. When these constraints are matched from a send to socket, reports a File Exfiltration.

A plugin specifies different ways that a given capability is to be identified. It lists one or more API sequences, their key arguments, and how constraints on their input and output parameters connect each other. The system has developed plugins to identify seven specific malware capabilities. Analysts can easily extend these plugins to specify additional capabilities by reviewing the API documentation of the target operating system. Next, we describe each capability, showing how a plugin can specify them.

Malware sends stolen information from an infected host by uploading a file to its drop site. This is done by using OpenFile and ReadFile APIs to copy data into a buffer followed by use of the send or HttpSendRequest network API. The plugin matches the constraints on the buffer written to by ReadFile with the buffer of data sent by send or HttpSendRequest. shows's analysis of AveMaria's file exfiltration.

Malware injects its code into a victim process to run under the target process ID. This is done by the OpenProcess or CreateProcess APIs, followed by WriteProcessMemory (process hollowing) and/or CreateRemoteThread (PE or DLL Injection). The plugin matches the input constraints on the process handle used by these APIs.

Malware writes a file to disk and changes its attributes for execution. The plugin matches the constraints on the file handle returned by CreateFile with the file handle input passed to WriteFile, as well as the file name passed to CreateFile, SetFileAttributes, and CreateProcess.

Malware records keystrokes and screenshots of a user's computer. To detect key spying, the plugin matches the constraints on the window handle passed to RegisterHotKey and GetMessage and checks if WH_KEYBOARD was passed to SetWindowsHook to monitor keystrokes. For screenshots, the plugin checks if a device context handle returned by GetDC or GetWindowDC is passed to CreateCompatibleBitmap. shows this analysis for AveMaria's screen spying.

Malware make registry entries to maintain persistence across reboots. The persistence plugin compares the constraints on the registry key handle returned by RegCreateKey or RegSetValue with the input to RegSetValue. The system also specifies the keys and subkeys that malware commonly use with these APIs, such as HKLM, HKCU, Run, and ControlSet.

Malware checks for analysis environments and tools to determine if it should hide its behavior. This can be done by checking for debuggers with OutputDebugString, IsDebuggerPresent, or CheckRemoteDebuggerPresent. VM checks look for running services by using CreateToolhelp32Snapshot or EnumProcesses or invoking cpuid to check for virtual CPUs. The plugin checks for usage of these APIs.

This plugin checks the arguments of socket (af is an IP address), InternetOpenUrl (lpszUrl is a domain), and IWinHttpRequest:: Open (lpszServerName is a domain or IP) to determine which servers are contacted. For domains that are represented by constant values or stored in memory (e.g., obtained from an external source such as file or socket), the plugin can successfully extract the domain. If the domain is from an external source and had not be stored in memory at the time of the memory capture, the plugin is unable to determine its concrete value. In the case of domains generated algorithmically, builds constraints on the bytes of the domain, seeds Z3 with the concrete execution data, and attempts to solve the constraints.

To develop these plugins, the inventors manually analyzed 50 samples and compiled many relevant API traces and their key arguments, similar to what an analyst would do. Since there are a finite number of ways malware can exhibit a given capability, one can expect to model most of those methods. In doing this, it was observed that there could be variations in API traces for the same capability, but the key APIs are always present. In addition, some APIs perform the same function, and hence can be interchanged. For example, WriteVirtualMemory can be interchanged for WriteProcessMemory in the process hollowing example. Furthermore, this approach is resilient to noisy API calls that malware authors may mix into their capability function. We provide additional details about the constraints for each plugin.

The paths where capabilities are found are known as capability paths or C_{Paths}. considers these paths to derive forecast percentages for discovered capabilities. For each capability cₓ along a path x, reports a forecast C_{cast}(cₓ) as a percentage. C_{cast}(cₓ) is derived from path probabilities of all C_{Paths}, and measures the probability that cₓ will be executed relative to other capabilities. Let the cardinality of Cₚₐₜₕₛ be m. A forecast is given as follows:

$$\{ ∀ i ∈ {C}_{Paths} : {C}_{c a s t} ( {c}_{x} ) = \frac{{P}_{prob} ( x )}{{\sum }_{i = 1}^{m} {P}_{prob} ( i )} ⨯ 100 \}$$

In the analysis, it was shown that the system overcomes the high cognitive burden on an analyst by forecasting future malware capabilities. The system is based on a formal probabilistic model, D_{c}(s), which allows the system to induce capability paths based on concrete data in a malware memory image. The system integrates memory image forensics and symbolic analysis in a feedback loop to efficiently explore malware with context. D_{c}(s) provides optimization metrics that enable the system to be practical for malware. The evaluation has shown that the system produces accurate forecasts of capabilities and outperforms existing techniques for identifying capabilities in malware.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of identifying capabilities of a malware intrusion that has been detected by an intrusion detection system, comprising the steps of:
(a) receiving from the intrusion detection system a notification that the malware intrusion has been detected;
(b) capturing a memory image associated with the malware;
(c) parsing the memory image and reconstructing a prior execution context by loading a last central processing unit (CPU) state and memory state into a symbolic environment;
(d) extracting addresses and prototype summaries associated with the malware from the memory image from the symbolic environment;
(e) determining paths that are possible for execution due to the malware based on the addresses and prototype summaries;
(f) modeling each path and assigning a probability of each path being executed with concrete data;
(g) pruning paths with a low probability of leaving a plurality of paths of interest;
(h) matching application programming interfaces (APIs) detected in the plurality of paths of interest to a repository of capability analysis plugins; and
(i) reporting to an analyst any application programming interface (API) that matches at least one plugin in the repository of capability analysis plugins.

2. The method of claim 1, wherein the step of extracting addresses and prototype summaries comprises inspecting loaded library functions in the memory image.

3. The method of claim 2, further comprising the step of leveraging available concrete data in the memory image to concretize path constraints.

4. The method of claim 1, wherein the step of modeling each path and assigning a probability of each path being executed with concrete data includes the step of weighing how each path is induced by concrete data.

5. The method of claim 1, wherein the step of pruning paths with a low probability of execution further comprises using the probability as a weight to adapt loop bounds.

6. The method of claim 1, further comprising the step of inspecting constraints of arguments included in paths with a high probability of execution so as to determine if the malware writes host information to a file, which it sends out a network.

7. The method of claim 1, wherein the step of reporting any APIs that match plugins in the repository of capability analysis plugins to an analyst comprises the step of generating instructing the analyst to block any URLs detected in a path associated with the malware.

8. The method of claim 1, further comprising the step of generating a text report that lists each malware capability discovered by the method, a forecast probability of execution of the capability expressed as a percentage, and an indication of a target of the capability.

9. The method of claim 1, wherein the step of assigning a probability of each path being executed with concrete data comprises assigning each path a degree of concreteness.

10. The method of claim 9, wherein the degree of concreteness for each path of interest is based on use of early concrete data by the path to execute a set of capabilities.

11. The method of claim 10, wherein degree of concreteness is determined by:
(a) determining a rate of change in the ratio of symbolic operations executed by the path to all operations executed by the path, with respect to state transitions; and
(b) summing the cumulative state conditions from a starting exploration state to a target state so as to generate a sum of cumulative state conditions; and
(c) dividing the sum of cumulative state conditions by a total number of ordered states, thereby generating the degree of concreteness.

12. The method of claim 1, wherein the step of pruning paths with a low probability of leaving a plurality of paths of interest, comprises the steps of;
(a) analyzing a stack backtrace of a selected path to prune false successor states;
(b) performing address concretization based on a process memory layout corresponding to the selected path; and
(c) simulating API calls via analysis of loaded library functions in the memory image.

13. The method of claim 12, wherein the step of analyzing a stack backtrace of a selected path to prune false successor states comprises the step of examining a forensic stack backtrace of the memory image to identify false paths whose function returns do not conform to previously established targets in a call stack.

14. The method of claim 13, further comprising the step of verifying flow-correctness of a path analysis by comparing a first stack pointer and return addresses in the stack backtrace with a second stack pointer computed after executing a return, wherein detection of a false state results in reporting an incorrect return and stack alignment.

15. The method of claim 12, wherein the step of performing address concretization includes using a data space of the memory image to concretize symbolic indices to a tractable range.

16. The method of claim 15, further comprising the step of detecting when a state performs an access wherein an index is beyond a mapped code or data space of a process and designated the state as a false state.

17. The method of claim 12, wherein the step of simulating API calls via analysis of loaded library functions in the memory image, comprises the steps of:
(a) analyzing the memory image to extract addresses and prototype summaries of loaded library functions; and
(b) simulating an effect of the API effect on a symbolic state without symbolically executing the code.

18. The method of claim 17, wherein the analysis of a function of the loaded library functions in the memory image yields a plurality of results, including:
(a) a number of arguments to the function;
(b) an indication of types of the arguments;
(c) an indicating of a calling convention for the function; and
(d) an indication of a return register for the function.

19. The method of claim 18, wherein on encountering an API call, leveraging function summaries and performing steps including:
(a) setting the return register of the function as symbolic and constraining the value of the return register to possible values specified by prototype information corresponding to the function; and
(b) if an argument of the function indicates writing to a memory location for an output buffer, then marking that memory location as symbolic.

20. The method of claim 12, further comprising analyzing symbolic constraints on the input and output parameters of each API to verify a shared state among each API.
